(19) United States
(12) Patent Application Publication
(10) Pub. No.: US 2010/0077317 A1
(43) Pub. Date: Mar. 25, 2010

(54) Providing Collaboration

(75) Inventors: Barry A. Kritt, Raleigh, NC (US); Thomas S. Mazzeo, Durham, NC (US); Rodney E. Shepard, II, Durham, NC (US)

Correspondence Address: Marcia L. Doubet Law Office, P.O. Box 422859, Kissimmee, FL, 34742-2859, US

(73) Assignee: INTERNATIONAL BUSINESS MACHINES CORPORATION, Armonk, NY (US)

(21) Appl. No.: 12/234,684

(22) Filed: Sep. 21, 2008

(51) Int. Cl. G06F 3/048; G06F 15/16

(52) U.S. Cl. 715/752; 709/206

(57) ABSTRACT

Collaboration support for collaboration among groups of people is provided by leveraging e-mail messaging. Content for collaboration messages is created, and is embedded within e-mail messages and sent to recipients (such as member of a collaboration team, managers who are identified for receiving notification of collaborations, and so forth). A template-driven approach may be used for creating the collaboration content. A unique identifier is associated with a particular collaboration and is included in each message pertaining to that collaboration, enabling those related messages to be correlated or aggregated.

### BACKGROUND OF THE INVENTION

The present invention relates to information technology, and deals more particularly with providing collaboration using message exchanges.

In today's work environment, there is frequently a need for collaborative work efforts. For example, groups of people may need to work together as a team to resolve issues. Collaboration software may be used for enabling the team members to communicate.

### BRIEF SUMMARY OF THE INVENTION

The present invention is directed to providing collaboration. In one aspect, this comprises embedding content for a collaboration in an e-mail message and sending the e-mail message to participants in the collaboration (optionally, excepting that one of the participants who provides the embedded content).

In another aspect, this comprises generating a unique identifier for a collaboration; embedding content for the collaboration in a plurality of e-mail messages for the collaboration; embedding the generated unique identifier in each of the plurality of e-mail messages, thereby enabling collecting together all of the plurality e-mail messages which embed content for the collaboration; inserting, in a message header of each of the plurality of e-mail messages, an indication that the content for the collaboration is embedded in that e-mail message; and sending each of the plurality of e-mail messages to participants in the collaboration (optionally, excepting that one of the participants who provides the embedded content for that e-mail message).

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates, at a high level, communication among collaborators, according to an embodiment of the present invention;

FIGS. 2, 5, and 11 illustrate sample graphical user interface views of collaboration messages, where these views may be displayed by an e-mail client of a team member participating in (or originating) a collaboration;

FIGS. 3, 7, and 9-10 illustrate sample graphical user interface views showing use of templates for creating and interacting with collaboration messages;

FIGS. 4, 6, and 8 provide flowcharts depicting logic which may be used when implementing embodiments of the present invention;

FIG. 12 depicts a data processing system suitable for storing and/or executing program code; and

FIG. 13 depicts a representative networking environment in which one or more embodiments of the present invention may be used.

### DETAILED DESCRIPTION OF THE INVENTION

Embodiments of the present invention are directed toward collaboration among groups of people. The people may be collaborating as a team for a work-related project, for example. (Note, however, that the reason for a particular collaboration is not limiting to the present invention, and a work-related theme is used herein by way of illustration but not of limitation). E-mail messaging is leveraged to provide collaboration support, whereby an embodiment of the present invention embeds collaboration content in e-mail messages, and those e-mail messages are transported between e-mail clients as if they were conventional e-mail messages, as will be discussed in more detail herein.

Collaboration software is sometimes referred to as “teamroom software” or a teamroom solution. One example is the Lotus Notes® software product marketed by International Business Machines Corporation (“IBM”). (“Lotus Notes” is a registered trademark of IBM in the United States, other countries, or both.)

Teamrooms may be used for assigning work items, managing issues, sharing information, tracking progress, and so forth. A drawback of some existing teamroom solutions is that setup processing is required, in advance, and administration of the teamroom is an ongoing requirement. For example, setting up a teamroom may require creating (i.e., defining) the teamroom, managing user security access, informing others of the teamroom location, creating categories for use in the teamroom, and so forth. Many current teamroom solutions also require a server for hosting the teamroom database. This requires hardware to be purchased and administered, in addition to administering the teamroom software.

In addition, allowing people outside the company that hosts the teamroom to participate in the teamroom (such as information technology employees in an outside company for which a software error is being debugged by the collaboration hosting company) may be problematic in known solutions, since the people in the outside company may not be able to access the teamroom due to security firewalls or other access restrictions. Web-based solutions that provide teamrooms have been developed in an attempt to resolve these issues. However, the setup processing and ongoing administrative requirements still exist in Web-based solutions known to the present inventors.

The overhead of setup processing efforts may be worthwhile on large projects, but often there are small or short-term efforts—including single-topic collaborations—where teams need to collaborate. In such cases, it is desirable to collaborate without the setup processing of a teamroom solution or other collaboration tool.

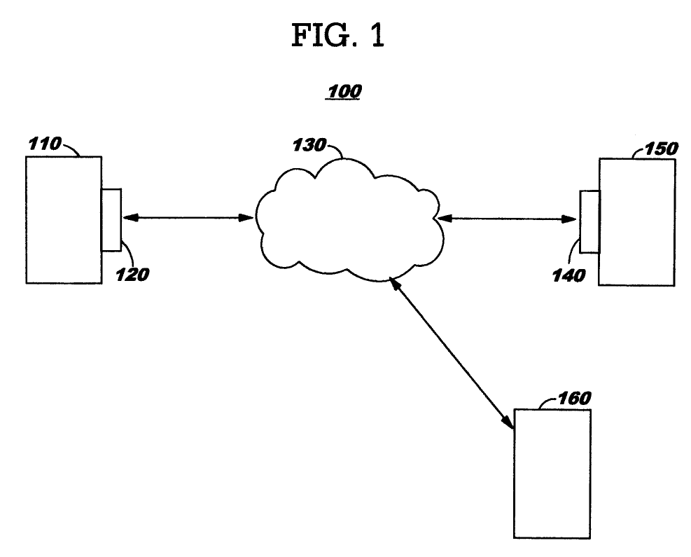

Embodiments of the present invention leverage e-mail support to provide a distributed approach to collaboration (which is in contrast to existing collaboration tools that use a centralized paradigm). Collaboration content is embedded in e-mail messages to provide collaboration information and capabilities. The high setup overhead of known collaboration techniques is therefore avoided. Plug-in software is used, in an approach illustrated in FIG. 1, to enable sending and receiving e-mail programs to interpret and display (or otherwise process) this embedded content, as will now be discussed.

Collaboration support as disclosed herein is distributed, in contrast to known centralized collaboration approaches. FIG. 1 illustrates a sample configuration 100 whereby e-mail clients 110, 150 adapted for use with the present invention are connected through a network 130 (such as the public Internet, a corporate intranet, or other network). E-mail client 110 uses plug-in software 120 and e-mail client 150 uses plug-in software 140 for providing distributed collaboration support using e-mail messages passed between clients 110, 150. (Use of plug-ins to provide collaboration support is illustrative but not limiting. Alternatively, an embodiment of the present invention may use another implementation approach for deploying the collaboration functionality disclosed herein.)

Note also that another e-mail client 160 is able to communicate with e-mail client 110 and/or 150 even though e-mail client 160 does not include a collaboration plug-in (or other collaboration support) as disclosed herein. Upon receiving an e-mail message containing collaboration content as disclosed herein, e-mail client 160 continues to interpret and process that e-mail message in a conventional manner (that is, as if the content was simply a conventional e-mail message) using e-mail application software of the client 160. (Note that the e-mail client 160 does not send collaboration content embedded in e-mail messages back to e-mail clients 110, 150 using techniques disclosed herein.)

A user of an embodiment of the present invention interacts with a collaboration message through the graphical user interface (“GUI”) of an e-mail application. (The term “collaboration message”, as used herein, refers to collaboration content embedded in an inbound e-mail message or prepared for transmission in an outbound e-mail message.) In one approach, the user may initiate a collaboration by selecting a collaboration choice—for example, using a drop-down menu, pop-up menu, tab, or icon—provided within the e-mail GUI, and may then begin to compose a collaboration message. In another approach, the user may compose a message within a conventional-style e-mail GUI, and then activate collaboration functionality (again, using a drop-down menu, pop-up menu, or other mechanism) to further process that message as collaboration content.

A number of different collaboration message types may be supported by an embodiment of the present invention. These message types include, by way of illustration but not of limitation, question-related or problem-related messages; informational messages; action item messages; investigation messages; team member voting or polling messages; and escalation messages. (An embodiment may support additional, fewer, or different message types without deviating from the scope of the present invention.)

A template may be provided for each collaboration message type, allowing a user to type content into fields of that template or to otherwise provide content for fields of the template (e.g., by copy and paste, drag and drop, and so forth). As one alternative to using a template, a user may select portions of already-provided content (using a conventional content selection approach, such as double-clicking with a pointing device or by dragging a pointing device while depressing a button to create a bounding box, for example) and may then identify a collaboration function to apply to that selected content. As an example of this latter approach, the user might highlight a section of text and, upon activating a right mouse button to display collaboration choices, might select “Use selection as collaboration topic” or “Use selection as collaboration message body”.

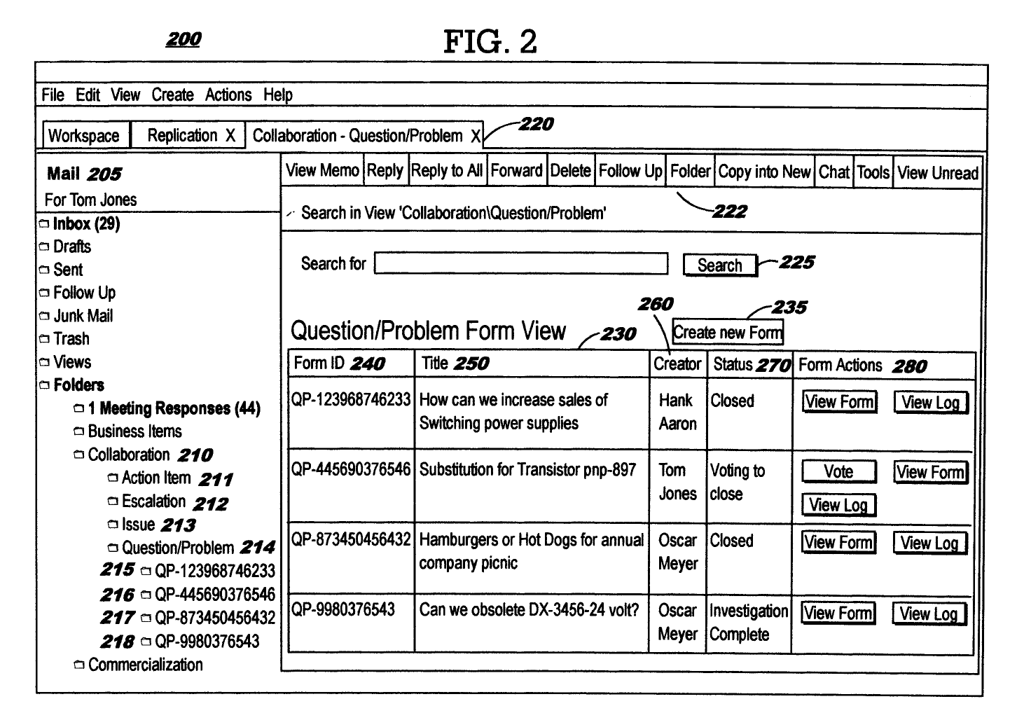

Embodiments of the present invention preferably organize received collaboration content using a folder approach, in a similar manner to folders that are used for organizing conventional e-mail messages. This is illustrated in the sample GUI 200 of FIG. 2, which may be displayed by the e-mail client of a hypothetical user “Tom Jones” for presenting a view of collaboration content. A hierarchical summary view 205 is depicted, where a “Collaboration” folder 210 appears as a highest-level folder and a number of lower-level folders 211-214 are shown for organizing content for various types of collaborations. In this example, folder 214 organizes content for the question/problem collaborations, and this folder 214 has been selected and expanded to show 4 individual instances of the question/problem collaboration type (see reference numbers 215-218). Instances of a collaboration type are also referred to herein simply as collaborations.

A “Collaboration—Question/Problem” tab 220 is presented in the sample GUI 200, responsive to selection of the question/problem folder 214, and a question/problem form view is therefore opened in a pane of the GUI, as shown generally at 230. In the example, a tabular view is provided, and this tabular view has an entry (i.e., a row in the table, in this example) corresponding to each of the instances 215-218. The sample question/problem form view 230 includes a column 240 for the unique identifier (“ID”) of this question/problem collaboration instance; a title column 250 that may be used for displaying a short description of the question/problem; a creator column 260 for identifying the team member who created this instance; a status column 270 for presenting a current status of this instance; and a form actions column 280 where available form actions may be represented (for example, as clickable buttons for invoking corresponding functionality). In an alternative approach, column 280 may be omitted and the actions may be invoked in another manner.

Sample GUI 200 also illustrates a toolbar 222 that presents a number of selectable choices which may be used for operating on collaboration content, and a search capability for searching within content of collaboration messages is illustrated at 225.

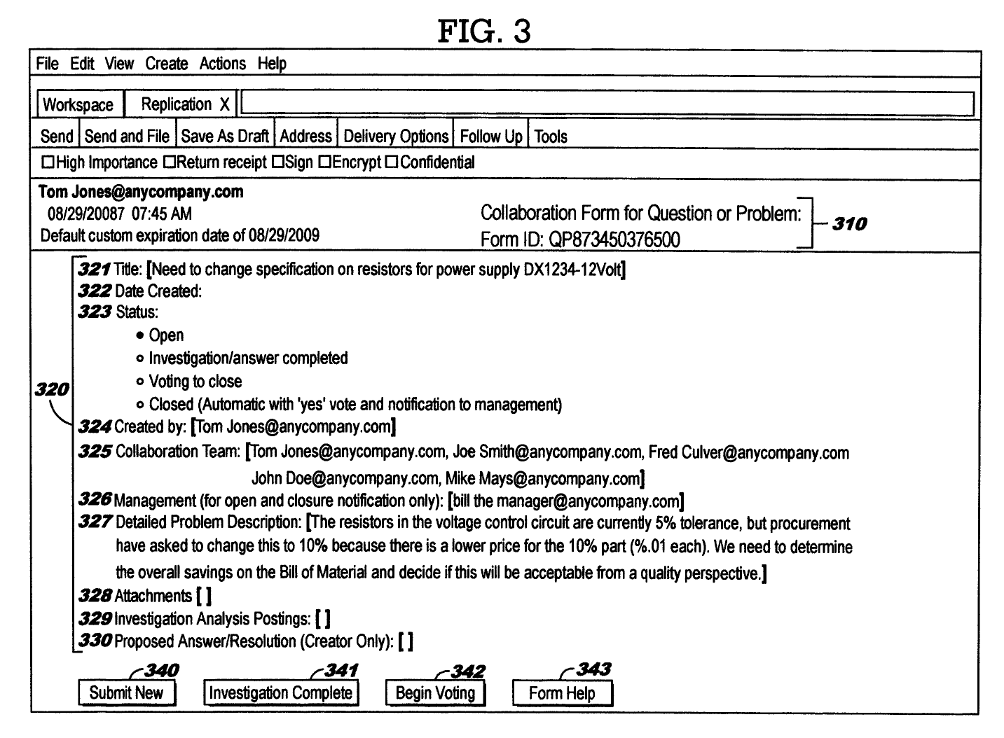

Suppose that the user wishes to initiate a new collaboration. The user may select the “Create new form” button 235 to initiate a collaboration having the currently-displayed question/problem collaboration type. FIG. 3 shows an example of a template view that may be provided, responsive to this selection, for creating the initial content for the collaboration. (To initiate a new collaboration of a type other than question/problem, the user might select a different one of the folders 211-213, and a button may be provided in a corresponding folder view for initiating a new collaboration of that type.)

Using templates, with their fixed and predetermined fields, ensures that team members who interact with collaboration messages (also referred to herein as “participants” in the collaboration) using an embodiment of the present invention will have uniform views of particular collaboration content. The fields provided by templates for each type of collaboration will typically vary, and the templates will serve to constrain content that may be provided for a collaboration instance of a particular type and to guide users in creating necessary content for a collaboration of that type.

As can be seen in FIG. 3, this example resembles a view that might be used for creating e-mail message content, but has been augmented to guide the user in creating content for a collaboration message. A unique identifier, referred to herein equivalently as a “form ID”, is programmatically created for this new collaboration message, and the identifier for this example is displayed at 310. (In the examples, instances of question/problem collaborations have form IDs that begin with “QP”, although this is merely illustrative.)

FIG. 3 also illustrates, in a message body area of the GUI, a template 320 having a number of data entry fields that may be used for specifying content pertaining to a question/problem collaboration. (The data entry fields are indicated in FIG. 3 and subsequent figures as being surrounded by opening and closing square brackets, although this syntax is by way of illustration only.) In this example, a Title field 321 of template 320 has user-provided text to describe the topic of the collaboration. A value for the Date Created field 322 and Status field 323 may be programmatically generated. A value for the Created By field 324 may be programmatically created, preferably by inserting the e-mail address of the user who initiates the creation of this instance. The user identifies the team members for this collaboration, as shown in this example by the e-mail address entries in the Collaboration Team field 325. Optionally, a Management field 326 may be used to identify a manager or managers to receive notification messages when a collaboration is opened and closed. A detailed description of the question/problem to which the collaboration pertains is entered at Detailed Problem Description field 327. Optionally, one or more attachments may be identified for transmitting with the e-mail message in which the collaboration message is embedded, as illustrated by Attachment field 328, and field 329 may be used for identifying Investigation Analysis Postings (although both fields 328 and 329 are empty/unused, in this example). A Proposed Answer/Resolution field 330 is provided, and may be used by the creator of the collaboration instance to describe a proposal. As will be obvious, the fields illustrated in FIG. 3 are provided by way of illustration but not of limitation, and an embodiment of the present invention may use additional, fewer, or different fields.

A group of buttons or icons may be provided, as shown at 340-343, to enable the user to invoke an action pertaining to the collaboration. In this example, a “Submit New [collaboration instance]” button 340 is selected by the user when data entry for the various fields 321-330 is complete. The value for field 322 may be created, for example, responsive to button 340 (and a value has therefore not been illustrated in FIG. 3 for field 322). Other illustrated selections include “Investigation Complete” button 341, “Begin Voting” button 342, and “Form Help” button 343. Button 341 may be activated, for example, when the team members have provided suggestions for resolving the question/problem. Button 342 may be activated, for example, when the collaboration creator has provided a proposed resolution at field 330, and wishes to have the team members vote on that proposal. Button 343 may be activated to provide context-sensitive help information pertaining to the question/problem template 320. As will be obvious, the buttons 340-343 illustrated in FIG. 3 are provided by way of illustration but not of limitation, and an embodiment of the present invention may use additional, fewer, or different choices.

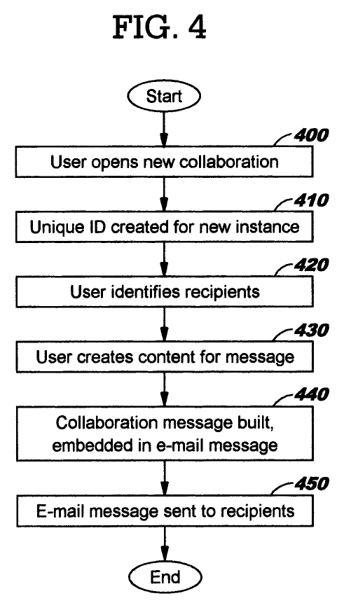

FIG. 4 provides a flowchart depicting logic which may be used when implementing an embodiment of the present invention, and corresponds to processing performed for a new outbound collaboration message—for example, responsive to creation of a new question/problem collaboration instance as illustrated in FIG. 3. This processing begins when a user opens a new collaboration (Block 400). A unique identifier is programmatically created (Block 410) for this new instance, as mentioned earlier. Preferably, the unique identifier includes a type code to distinguish among the various types of collaboration. For example, a type code of “QP” may appear at the beginning (or end) of the identifiers for all question/problem collaborations. Alternatives include use of numeric values that are mapped to the types of the collaboration messages, other types of string value, and so forth.

The user identifies the recipients for the collaboration message (Block 420). As discussed above with respect to fields 325 and 326 of FIG. 3, the recipients may include team members who are invited as participants in the collaboration as well as others (such as managers) who will receive the collaboration message as a notification. The user also provides content for the collaboration message (Block 430), which may comprise entering data for various fields of a template such as template 320 in FIG. 3.

An embodiment of the present invention then builds a collaboration message comprising the user-provided input and programmatically-generated information, and embeds that collaboration message into an e-mail message (Block 440). The e-mail addresses from field 325 of template 320 may be programmatically supplied as the “to:” list for the e-mail message. The “from:” address for the e-mail message may be set to the e-mail address associated with the user of the e-mail client at which the updates are created. (This particular e-mail address is preferably removed when building the “to:” list.) Optionally, a “cc:” list for the e-mail message may be composed from the e-mail addresses from field 326. The e-mail message “subject” may be programmatically built from field 321, and the body of the e-mail message preferably contains all of the content from template 320 (including headers or codes to distinguish among the various fields). The unique collaboration ID value, illustrated in the example at 310, may be inserted into a message header of the e-mail message. The e-mail message, with its embedded collaboration content, is then sent to the recipients (Block 450), after which the processing of FIG. 4 ends.

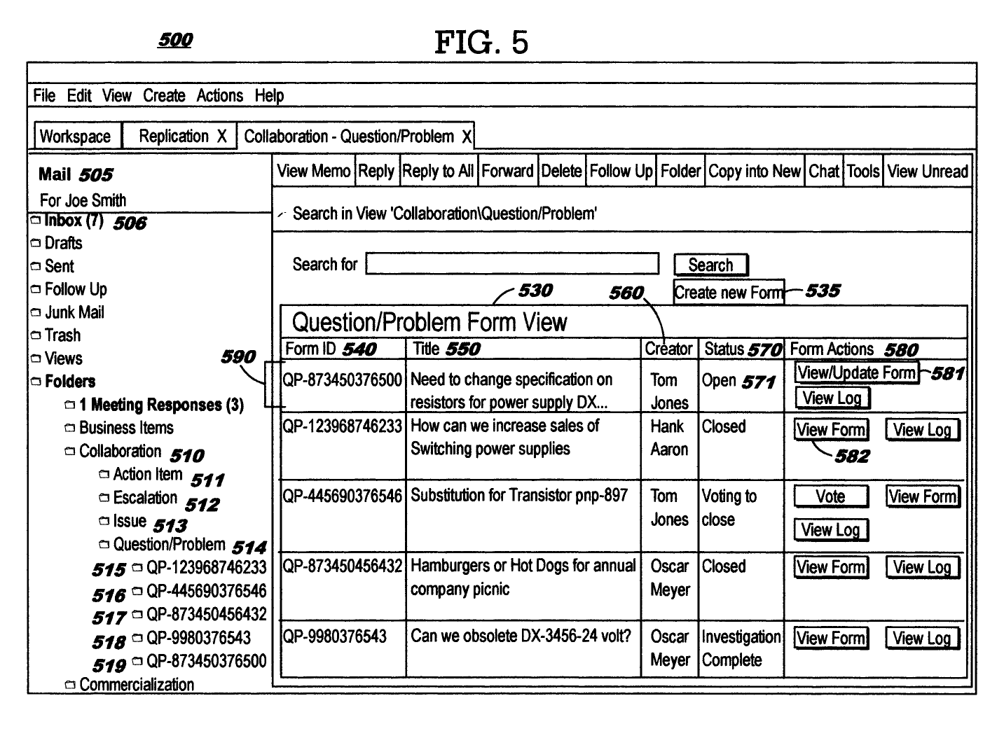

FIG. 5 illustrates a sample GUI 500, which may be displayed by the e-mail client of a recipient of the question/problem collaboration message created according to the example of FIG. 3. This sample GUI 500 is presented for a hypothetical user “Joe Smith” (who is identified in recipient list 325 of FIG. 3). Hierarchical summary view 505 is similar to hierarchical summary view 205, but now includes an entry 519 for the newly-created question/problem collaboration from FIG. 3. Form view 530 is similar to form view 230 of FIG. 2, but now includes an additional row in the table to represent this newly-created question/problem collaboration. See row 590.

As noted above with respect to e-mail client 160 in FIG. 1, if the recipient of an e-mail message with embedded collaboration content does not have functionality (such as a plug-in) installed for processing collaboration messages according to an embodiment of the present invention, then the e-mail message may be routed to that recipient's incoming mailbox and processed as if it were a conventional e-mail message. This may comprise displaying the information from FIG. 3 as free-form text, by way of example. In addition, the message count of messages in the user's “Inbox”, shown at 506 of FIG. 5, may be incremented to include the e-mail message that embeds the collaboration message.

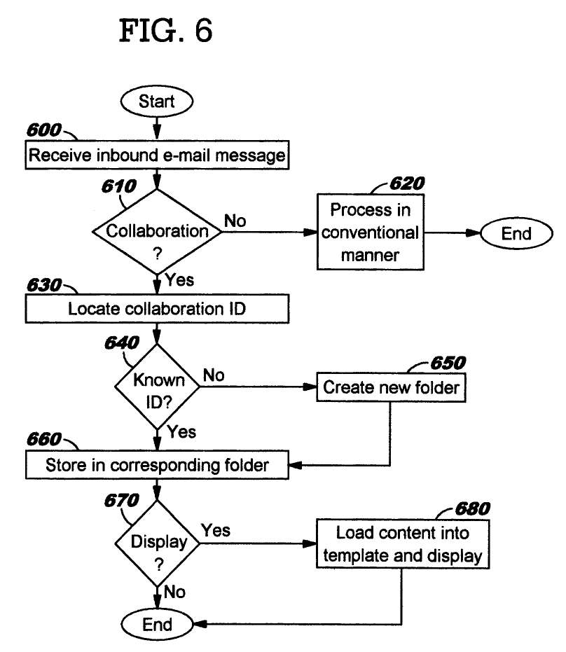

FIG. 6 provides a flowchart depicting logic that may be used when implementing an embodiment of the present invention, and corresponds to processing performed for a newly-received inbound collaboration message—for example, responsive to receiving the inbound message that embeds the question/problem collaboration instance discussed above with regard to FIGS. 3 and 5. This processing begins when the e-mail message arrives at a recipient (Block 600), such as e-mail client 150 of FIG. 1. Block 610 tests whether this newly-arriving e-mail message embeds collaboration content. This may be determined, for example, by checking for presence of a particular message header value or values provided as an indicator that the e-mail message embeds collaboration content. If this test has a negative value, then this e-mail message does not embed collaboration content, and the e-mail message is processed in a conventional manner (Block 620), after which the processing of FIG. 6 ends.

When the test in Block 610 has a positive result, on the other hand, then this is an e-mail message with an embedded collaboration message. Processing therefore continues at Block 630 by locating the unique collaboration ID from the message (e.g., by searching the message headers). Block 640 tests whether this collaboration ID is already known at the receiver. If not, then the recipient has not yet processed any messages pertaining to this particular collaboration. Block 650 therefore creates a new folder for this collaboration. This may comprise, for example, creating a subdirectory for the collaboration within a directory structure that corresponds to a collaboration type indicated by the collaboration ID. See reference number 519 of FIG. 5, for example, representing a new folder at a child level of question/problem folder 514. One directory may correspond to question/problem folder 514 when using this approach, and this directory may have individual subdirectories for each of the folders 515-519.

Block 660 stores the incoming e-mail message in the corresponding folder—that is, in an existing folder when control reaches Block 660 from Block 640, and in the newly-created folder when control reaches Block 660 from Block 650. An embodiment of the present invention correlates the collaboration ID on all messages that pertain to a particular initially-created collaboration, thereby enabling updates and various other responses to be organized and collected together. A particular folder or directory may therefore store multiple messages. In one approach, all of the related messages (that is, all of the messages that pertain to a particular initially-created collaboration) contain the same unique collaboration ID, and the individual messages each contain a unique timestamp value. Providing the unique collaboration ID on the related messages enables aggregating the messages, and the timestamps enable sorting or ordering the messages (e.g., for sequential display). The unique timestamp value may be appended to, or separate from, the collaboration ID. Because team members may be geographically dispersed, a time-keeping convention such as Greenwich Mean Time (“GMT”) or Universal Time (“UT”) may be used for the timestamp.

Block 670 tests whether this newly-arrived e-mail message, and its embedded collaboration message, is to be displayed on the recipient's e-mail GUI. If not, then the processing of FIG. 6 ends. Otherwise, Block 680 locates a template corresponding to the collaboration type—which may be determined from the collaboration ID located at Block 630—and displays the collaboration content within that template. Processing of FIG. 6 then ends.

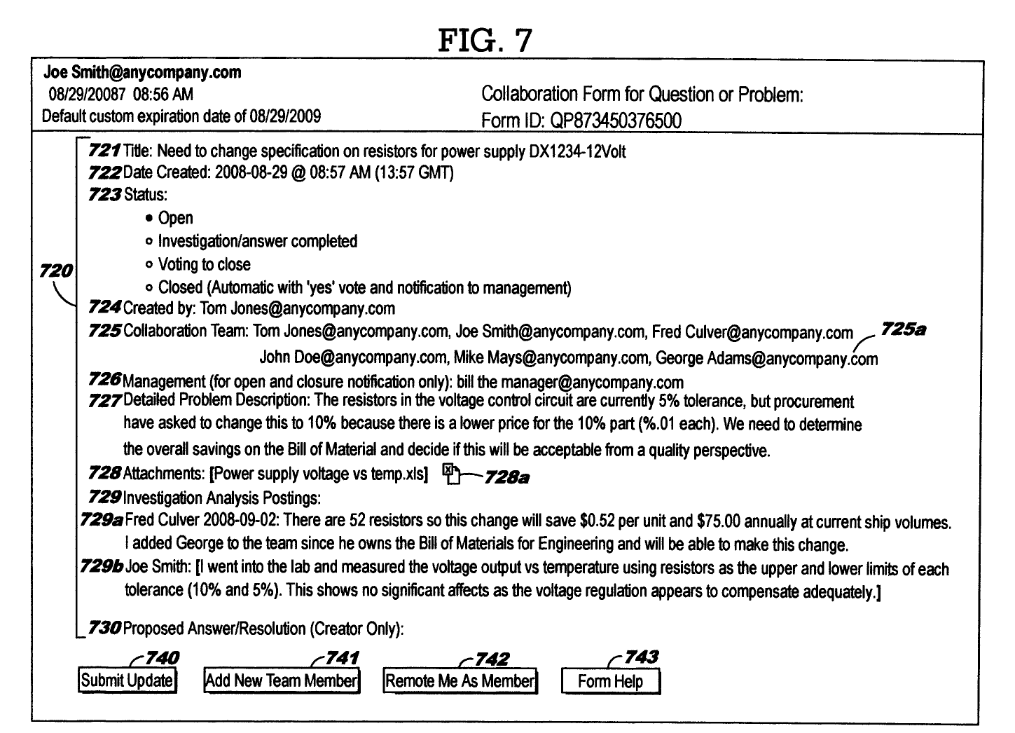

A recipient of collaboration messages (such as a team member) may update, respond to, or otherwise interact with a previously-received collaboration message. The recipient may navigate the hierarchical summary view, as illustrated at 205 in FIG. 2 and 505 in FIG. 5, to locate a collaboration of interest. As one alternative, an embodiment of the present invention may provide a search field (as discussed above with regard to 225 of FIG. 2) for searching within content of collaboration messages to locate a particular collaboration of interest. As another alternative, the recipient choose a “View Form” or “View/Update Form” option from a form view, such as form view 530 of FIG. 5. (See buttons 582, 581 of FIG. 5, respectively.) Upon locating the collaboration, a view thereof may be displayed in the e-mail GUI and the recipient may be allowed to interact with that view, as will now be discussed with reference to FIG. 7.

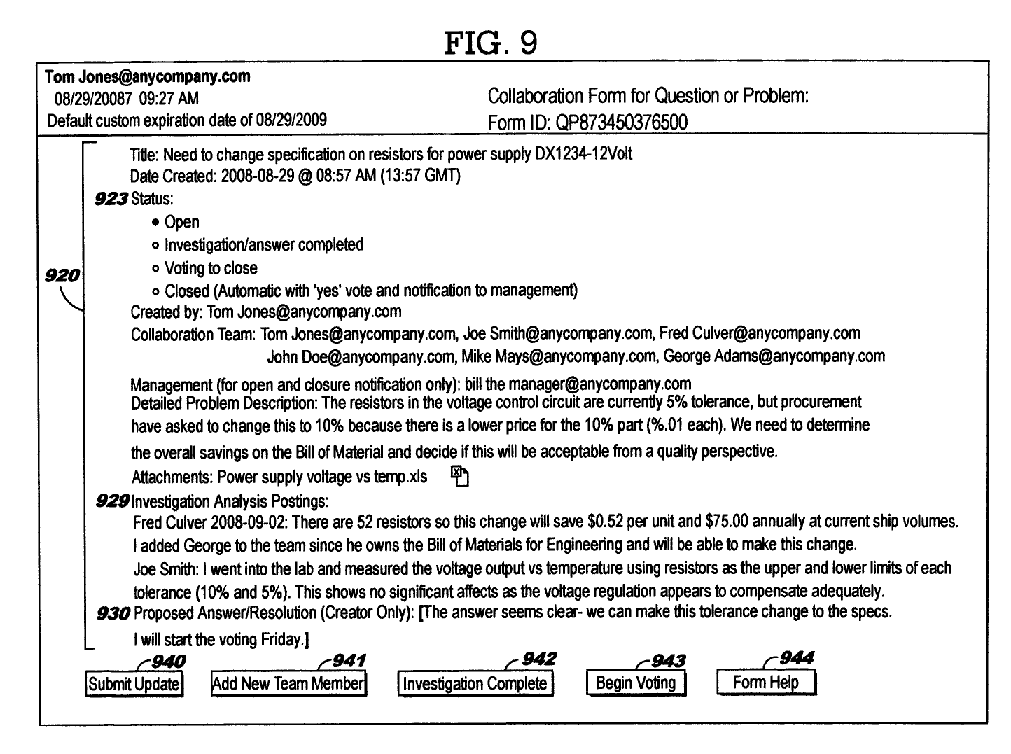

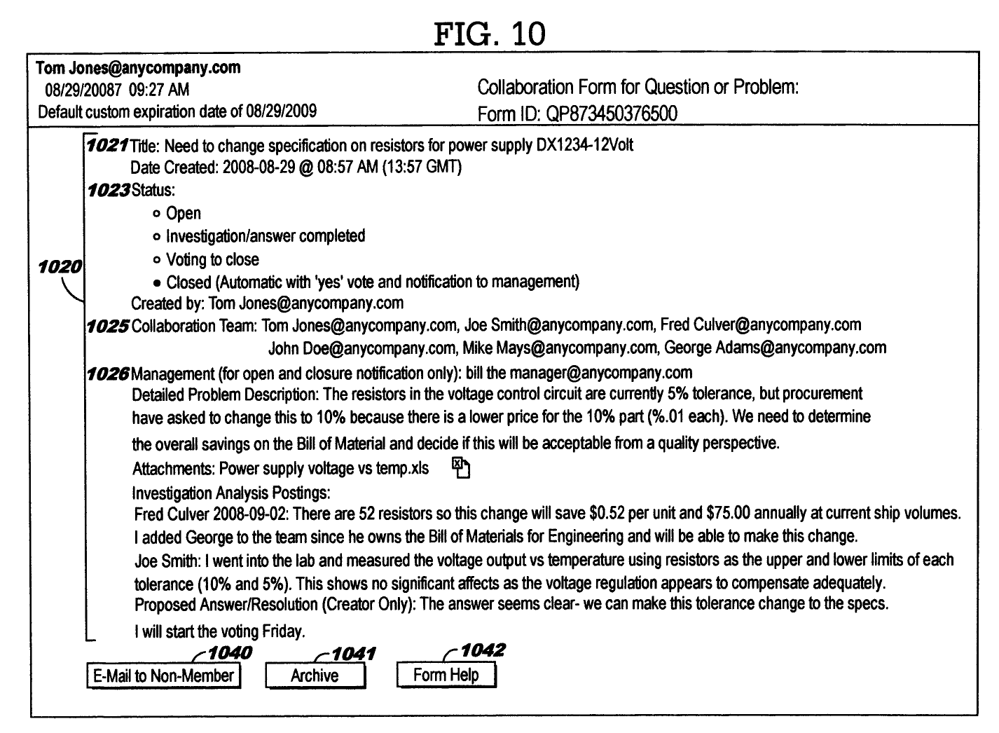

FIG. 7 illustrates an example of a recipient's view of the collaboration message that corresponds to template 320 of FIG. 3. (As contrasted to FIGS. 3 and 5, headings have been removed from FIG. 7, as well as from FIGS. 9 and 10, for drafting convenience.) By way of review, template 320 was used to create a new question/problem collaboration instance. An embodiment of the present invention may “lock” one or more of the fields of a particular template once the initial message content has been created, such that those fields cannot be changed in the collaboration instance. Accordingly, fields 721, 723, 724, and so forth are illustrated in template 720 of FIG. 7 as display-only (i.e., non-update) fields. Note that field 722 is also a display-only field, and shows the date and time at which the collaboration was initially created.

In the example, collaboration template 720 is displayed for the recipient “Joe Smith”, and the corresponding question/problem collaboration instance has already been updated by a different recipient. See entry 729a in field 729, where a recipient “Fred Culver” has provided a posting pertaining to this question/problem collaboration. Entry 729a is depicted in FIG. 7 as a display-only field. A data entry field 729b is also displayed (in this example, appearing underneath entry 729b), and provides a text entry field for user Joe Smith to insert content. The example also shows, at 728a, that this user “Joe Smith” has identified an attachment for transmitting with the e-mail message in which his update to the collaboration message is embedded.

A group of buttons or icons may be provided, as shown at 740-743, to enable the user to invoke an action pertaining to the collaboration. In this example, a “Submit Update” button 740 is selected by the user when his data entry updates (that is, fields 728a, 729b, in this example) are complete and he wishes to submit those updates. Other illustrated selections include “Add New Team Member” button 741, “Remove Me As Member” button 742, and “Form Help” button 743. As will be obvious, the buttons 740-743 illustrated in FIG. 7 are provided by way of illustration but not of limitation, and an embodiment of the present invention may use additional, fewer, or different choices. FIG. 7 illustrates a result of adding a new team member to the address list at 725; see 725a.

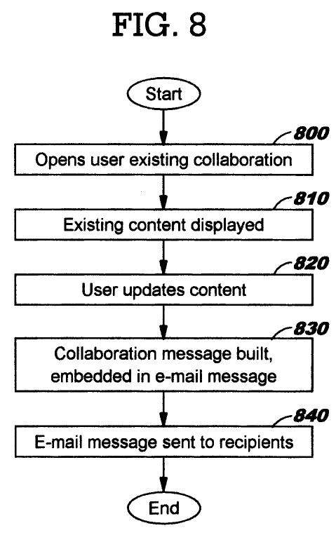

FIG. 8 provides a flowchart depicting logic which may be used when implementing an embodiment of the present invention, and corresponds to processing performed for updating a collaboration message—for example, responsive to updates of an existing question/problem collaboration instance as illustrated in FIG. 7. This processing begins when a user opens an existing collaboration (Block 800). Currently-existing content for the collaboration is displayed (Block 810). The user provides updated content for the collaboration (Block 820), which may comprise entering data for one or more fields of a template such as template 720 in FIG. 7.

An embodiment of the present invention then builds a collaboration message comprising the existing content and user-provided updates, and embeds that collaboration message into an e-mail message (Block 830). The collaboration message also includes the collaboration ID of the original collaboration, thereby enabling the updates to be correlated with previous messages for this collaboration. As noted earlier, the message also contains a unique timestamp value (which is programmatically generated) corresponding to the time of the update, and these timestamps may be used to sequentially order related messages for the collaboration. The e-mail addresses for the team members are contained within the collaboration message (as shown at field 725 of template 720), and may be programmatically supplied as the “to:” list for the e-mail message. The “from:” address for the e-mail message may be set to the e-mail address associated with the user of the e-mail client at which the updates are created. (This particular e-mail address is preferably removed when building the “to:” list.) Optionally, a “cc:” list for the e-mail message may be composed from the e-mail addresses from field 726. The e-mail message “subject” may be programmatically built from field 721, and the body of the e-mail message preferably contains all of the content from template 720 (including headers or codes to distinguish among the various fields). The unique collaboration ID value, illustrated in the example at 710, may be inserted into a message header of the e-mail message.

The e-mail message, with its embedded, newly-updated collaboration content, is then sent to the recipients (Block 840), after which the processing of FIG. 8 ends.

At some point, the creator of a particular collaboration instance may decide that this collaboration is complete. The collaboration creator may navigate the hierarchical summary view, as illustrated at 205 in FIG. 2 and 505 in FIG. 5, to locate a collaboration of interest. Other alternatives include using a search field to locate a collaboration message or selecting a button associated with a collaboration within a form view (as discussed above with regard to 225 of FIG. 2 and 581, 582 of FIG. 5) to locate a particular collaboration of interest. Upon locating the collaboration, a view thereof may be displayed in the e-mail GUI and the recipient may be allowed to interact with that view, as will now be discussed with reference to FIG. 9.

FIG. 9 illustrates an example of the collaboration creator's view of the collaboration message, shown in template 920 as the question/problem collaboration of the example scenario. In the example, the user provides content in field 930, describing an answer or resolution of this collaboration. Note that Status field 923 shows the collaboration status as being currently “Open”, and that field 929 includes all of the previously-entered postings for this collaboration instance.

A group of buttons or icons may be provided, as shown at 940-944, to enable the user to invoke an action pertaining to the collaboration. In this example, the illustrated selections include “Submit Update” button 940, “Add New Team Member” button 941, “Investigation Complete” button 942, “Begin Voting” button 943, and “Form Help” button 944. As will be obvious, the buttons 940-944 illustrated in FIG. 9 are provided by way of illustration but not of limitation, and an embodiment of the present invention may use additional, fewer, or different choices. (As contrasted to the view shown in FIG. 7, the view shown in FIG. 9 does not include a “Remove Me As Member” button. An embodiment of the present invention may omit this button when displaying a view for the collaboration creator, or may display the button but disable its functionality.)

When the collaboration creator selects the “Investigation Complete” button 942, the status of the collaboration is changed to closed, and a notification message may be sent by embedding an updated collaboration message in an e-mail message. Logic for creating this message may operate as discussed above with respect to FIG. 8. By way of review, this processing may comprise:
programmatically supplying the e-mail addresses from field 1025 of template 1020 as the “to:” list for the e-mail message;
setting the “from:” address for the e-mail message to the e-mail address associated with the user of the e-mail client at which this update is created (and this particular e-mail address is preferably removed when building the “to:” list);
composing a “cc:” list for the e-mail message from the e-mail addresses from field 1026, thereby notifying these users that the collaboration is now closed;
programmatically building the e-mail message “subject” from field 1021;
programmatically building the body of the e-mail message to contain all of the content from template 1020 (including headers or codes to distinguish among the various fields);
inserting the unique collaboration ID value that identifies this collaboration into a message header of the e-mail message; and
then sending the e-mail message, with its embedded collaboration content, to the recipients.

A resulting view of closing the collaboration instance of the example question/problem scenario is shown in FIG. 10, where the collaboration content is depicted in template 1020. Note that Status field 1023 now shows the status of the collaboration as “Closed”. While no more updates to the collaboration instance are permitted at this point, a group of buttons or icons may optionally be provided, as shown at 1040-1042, to enable the user to invoke further action pertaining to the collaboration. In this example, the illustrated selections include “E-Mail to Non-Member” button 1040, “Archive” 1041, and “Form Help” button 1042. As will be obvious, the buttons 1040-1042 illustrated in FIG. 10 are provided by way of illustration but not of limitation, and an embodiment of the present invention may use additional, fewer, or different choices.

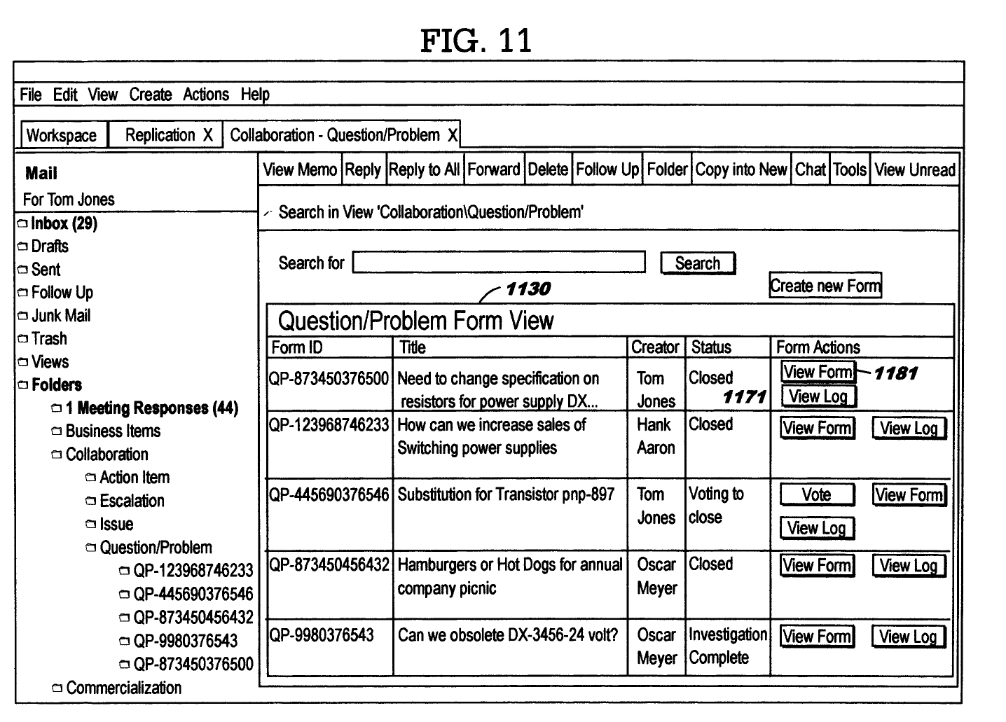

Referring now to FIG. 11, a sample GUI 1100 is illustrated, showing a form view 1130 which may be displayed by the e-mail client of the creator of the question/problem collaboration message after the collaboration is closed according to the example of FIG. 9. Form view 1030 is similar to form view 530 of FIG. 5, but now shows updated status at 1171 (i.e., showing this collaboration as now closed, in contrast to “OPEN” as shown at 571). In addition, the example shows a form action choice of “View Form” at 1181 (in contrast to “View/Update Form” shown at 581).

Team members may be invited to vote on proposed solutions for question/problem collaborations. This may occur responsive to the collaboration creator selecting a “Begin Voting” button as illustrated at 943 of FIG. 9. As each team member votes, an e-mail message with embedded content representing the collaboration vote (which may optionally include comments by the team member, in addition to the vote) is distributed to the other team members, in a similar manner to that which has been discussed above with regard to FIG. 8.

Variations may exist in the collaboration support provided by different embodiments of the present invention, without deviating from the scope of the present invention. Examples include templates allowing a collaboration creator to specify a date by which a team member's answer is expected; a date by which a problem resolution is expected; an identification of e-mail addresses for persons to be notified when an escalation is deemed necessary for a particular collaboration; a security classification for a collaboration; and so forth. Furthermore, while the sample views (such as FIG. 7) depict a full-screen representation for a single collaboration message, this is by way of illustration and not of limitation. Additional or different views may be provided, for example, where each of the related messages for a particular collaboration is represented, thereby providing a type of team room overview. Various types of reports may also be supported by an embodiment of the present invention, including logs of collaboration messages, summaries of collaborations, identifications of current team members for collaborations, and so forth.

Optionally, functionality may be provided for exporting a collaboration or collection of collaborations (including of all the related messages for each collaboration). As one example, this exporting may be useful when the collaboration history documents how a problem was resolved. The exported information may be used as an entry in a “frequently-asked questions”, or “FAQ”, repository, for example. As another example, team collaboration may be used for creating a user guide or other publication, whereby different team members are responsible for creating different chapters or other portions of the publication. Once the various contributions are ready, they may be exported for aggregating into a consolidated publication, for storage on a content server, and so forth.

While sample GUI views (such as GUI 200 of FIG. 2 and GUI 500 of FIG. 5) have been described herein as showing collaboration messages stored in folders that are separate from a recipient's inbox, this is by way of illustration and not of limitation. As one alternative, a message may appear in the recipient's inbox as a notification that a new collaboration message (which may pertain to a new collaboration, or a collaboration for which messages have already been received at the recipient's e-mail client) has been received and routed to its corresponding collaboration folder.

Collaboration messages may be stored in storage that is local to, or locally-accessible to, a team member's computing resources. In one approach, collaboration content is extracted each time an e-mail message embedding collaboration content is received at the local e-mail client, and this extracted content is used to populate a local collaboration data repository. Views of collaboration content may then be created from entries in the collaboration data repository. In another approach, the original e-mail messages that embed the collaboration content are maintained, and views of collaboration content are generated by processing the embedded content.

If a new team member is added to an already-existing collaboration, an embodiment of the present invention may distribute existing collaboration content to that new team member, such that the team member's e-mail client can display a full history of the collaboration (for example, by presenting of view of all of the previously-exchanged collaboration messages). This may comprise a “push” of content, whereby content is distributed to the e-mail client of the new team member from the (existing) team member who adds the new team member. As one alternative, a “pull” approach may be used, whereby the new team member's e-mail client requests the full history of the collaboration. A target of this request may be, for example, the creator of the collaboration. In both the “push” and “pull” approach, an automated distribution request may be generated, responsive to the addition of the team member. When the original e-mail messages that embed the collaboration content are maintained, these e-mails may be distributed directly to the new team member. When collaboration content is extracted and stored in a collaboration repository without maintaining the original e-mail messages, new e-mail messages may be programmatically generated to distribute the existing collaboration content to the new team member (in an analogous manner to that which has been described above, with regard to FIGS. 4 and 8, for building e-mail messages to send newly-created content to team members).

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

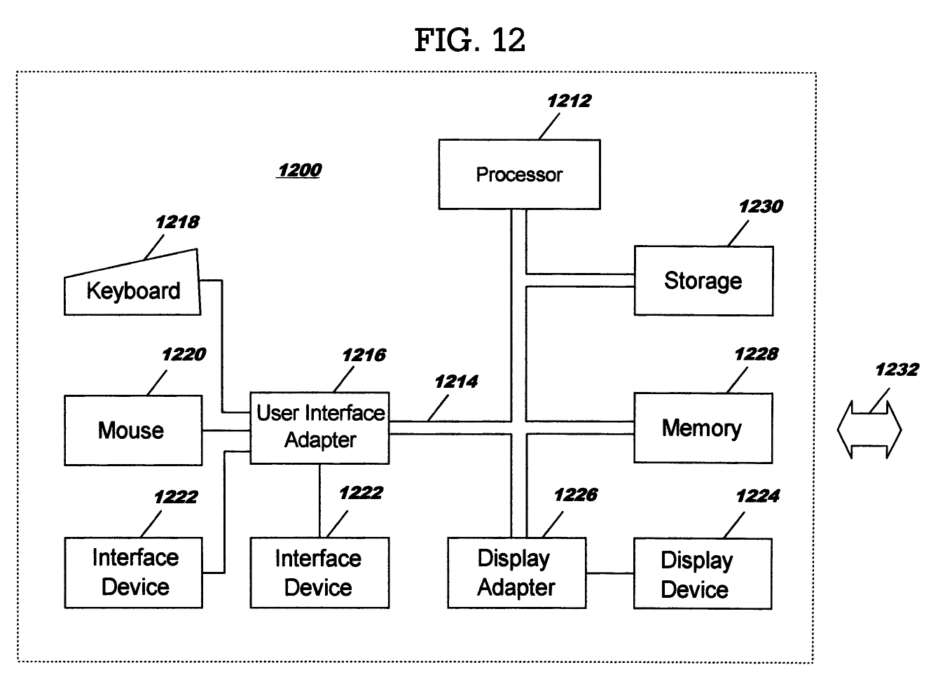

Referring now to FIG. 12, a data processing system 1200 suitable for storing and/or executing program code includes at least one processor 1212 coupled directly or indirectly to memory elements through a system bus 1214. The memory elements can include local memory 1228 employed during actual execution of the program code, bulk storage 1230, and cache memories (not shown) which provide temporary storage of at least some program code in order to reduce the number of times code must be retrieved from bulk storage during execution.

Input/output (“I/O”) devices (including but not limited to keyboards 1218, displays 1224, pointing devices 1220, other interface devices 1222, etc.) can be coupled to the system either directly or through intervening I/O controllers or adapters (1216, 1226).

Network adapters may also be coupled to the system to enable the data processing system to become coupled to other data processing systems or remote printers or storage devices through intervening private or public networks (as shown generally at 1232). Modems, cable modem attachments, wireless adapters, and Ethernet cards are just a few of the currently-available types of network adapters.

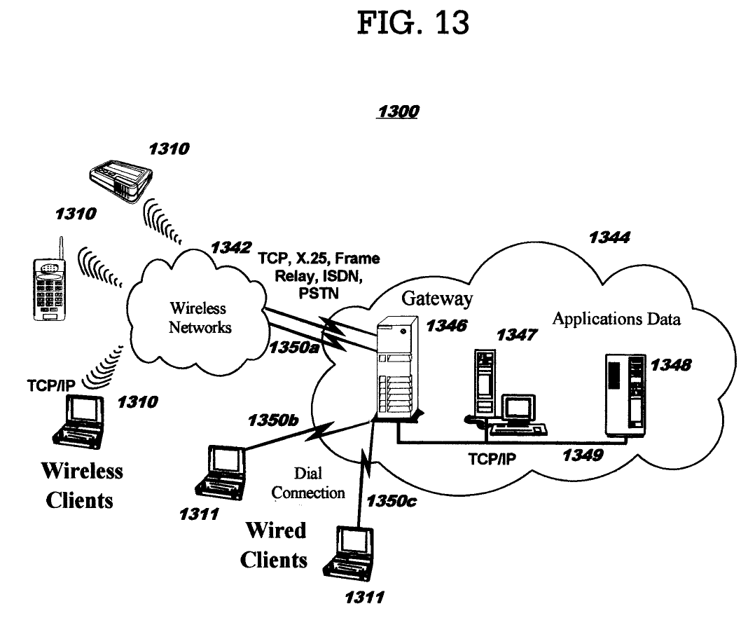

FIG. 13 illustrates a data processing network environment 1300 in which the present invention may be practiced. The data processing network 1300 may include a plurality of individual networks, such as wireless network 1342 and wired network 1344. A plurality of wireless devices 1310 may communicate over wireless network 1342, and a plurality of wired devices, shown in the figure (by way of illustration) as workstations 1311, may communicate over wired network 1344. Additionally, as those skilled in the art will appreciate, one or more local area networks (“LANs”) may be included (not shown), where a LAN may comprise a plurality of devices coupled to a host processor.

Still referring to FIG. 13, the networks 1342 and 1344 may also include mainframe computers or servers, such as a gateway computer 1346 or application server 1347 (which may access a data repository 1348). A gateway computer 1346 serves as a point of entry into each network, such as network 1344. The gateway 1346 may be preferably coupled to another network 1342 by means of a communications link 1350a. The gateway 1346 may also be directly coupled to one or more workstations 1311 using a communications link 1350b, 1350c, and/or may be indirectly coupled to such devices. The gateway computer 1346 may be implemented utilizing an Enterprise Systems Architecture/390® computer available from IBM. Depending on the application, a midrange computer, such as an Application System/400® (also known as an AS/400®), iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 1346 may also be coupled 1349 to a storage device (such as data repository 1348).

Those skilled in the art will appreciate that the gateway computer 1346 may be located a great geographic distance from the network 1342, and similarly, the wireless devices 1310 and/or workstations 1311 may be located some distance from the networks 1342 and 1344, respectively. For example, the network 1342 may be located in California, while the gateway 1346 may be located in Texas, and one or more of the workstations 1311 may be located in Florida. The wireless devices 1310 may connect to the wireless network 1342 using a networking protocol such as the Transmission Control Protocol/Internet Protocol (“TCP/IP”) over a number of alternative connection media, such as cellular phone, radio frequency networks, satellite networks, etc. The wireless network 1342 preferably connects to the gateway 1346 using a network connection 1350a such as TCP or User Datagram Protocol (“UDP”) over IP, X.25, Frame Relay, Integrated Services Digital Network (“ISDN”), Public Switched Telephone Network (“PSTN”), etc. The workstations 1311 may connect directly to the gateway 1346 using dial connections 1350b or 1350c. Further, the wireless network 1342 and network 1344 may connect to one or more other networks (not shown), in an analogous manner to that depicted in FIG. 13.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A method for providing collaboration, comprising:
embedding content for a collaboration in an e-mail message; and
sending the e-mail message to participants in the collaboration.

2. The method according to claim 1, further comprising providing the content using a collaboration template.

3. The method according to claim 2, wherein the collaboration template dictates what content is needed in view of a type of the collaboration.

4. The method according to claim 1, wherein a message header of the e-mail message indicates that the content for the collaboration is embedded in the e-mail message.

5. The method according to claim 1, further comprising generating a unique identifier for the collaboration, and wherein the embedding also embeds the generated unique identifier in the e-mail message.

6. The method according to claim 5, further comprising:
upon subsequently creating further content for the collaboration, embedding the further content and the generated unique identifier for the collaboration in a subsequent e-mail message; and
sending the subsequent e-mail message to the participants.

7. The method according to claim 6, wherein the embedded unique identifier enables collecting together all of the e-mail messages which embed content for the collaboration.

8. The method according to claim 1, further comprising:
detecting, upon receiving the e-mail message by a particular one of the participants, that the content for the collaboration is embedded therein; and
storing the embedded content in a collaboration repository for the participant, responsive to the detecting.

9. The method according to claim 8, further comprising:
responding to a request for displaying the embedded content by retrieving the stored extracted content and displaying the retrieved extracted content on a display screen.

10. The method according to claim 1, further comprising:
detecting, upon receiving the e-mail message by a particular one of the participants, that the content for the collaboration is embedded therein; and
storing the e-mail message, responsive to the detecting.

11. The method according to claim 10, further comprising:
responding to a request for displaying the embedded content by extracting the embedded content and displaying the extracted content on a display screen.

12. The method according to claim 11, wherein the display screen is presented by an e-mail application.

13. The method according to claim 1, further comprising processing the e-mail message as a conventional e-mail message upon receiving the e-mail message at one of the participants whose e-mail client is not adapted for detecting the embedded collaboration content.

14. The method according to claim 1, further comprising providing a representation of the collaboration in a hierarchical summary view of an e-mail application.

15. The method according to claim 1, wherein the sending sends the e-mail message to participants in the collaboration excepting that one of the participants who provides the embedded content for that e-mail message.

16. A system for providing collaboration, comprising:
a computer comprising a processor; and
instructions executable using the processor, the instructions configured to:
embed content for a collaboration in an e-mail message; and
send the e-mail message to participants in the collaboration.

17. The system according to claim 16, wherein the instructions configured for sending send the e-mail message to participants in the collaboration excepting that one of the participants who provides the embedded content for that e-mail message.

18. A computer program product for providing collaboration, the computer program product embodied on at least one computer-readable medium and comprising computer-readable program code for:
generating a unique identifier for a collaboration;
embedding content for the collaboration in a plurality of e-mail messages for the collaboration;
embedding the generated unique identifier in each of the plurality of e-mail messages, thereby enabling collecting together all of the plurality e-mail messages which embed content for the collaboration;
inserting, in a message header of each of the plurality of e-mail messages, an indication that the content for the collaboration is embedded in that e-mail message; and
sending each of the plurality of e-mail messages to participants in the collaboration.

19. The computer program product according to claim 18, wherein the computer-readable program code for sending sends the e-mail message to participants in the collaboration excepting that one of the participants who provides the embedded content for that e-mail message.
